(19) United States
(12) Patent Application Publication
(10) Pub. No.: US 2020/0005375 A1
(43) Pub. Date: Jan. 2, 2020

(54) VIRTUAL ASSISTANT GUIDANCE BASED ON CATEGORY FAMILIARITY

(71) Applicant: eBay Inc., San Jose, CA (US)

(72) Inventors: Yotam Sharan, Tenafly, NJ (US); Nicole Hibbard Lyon, San Jose, CA (US); Nicholas Roberts, San Francisco, CA (US)

(21) Appl. No.: 16/019,770

(22) Filed: Jun. 27, 2018

(51) Int. Cl. G06Q 30/06; H04L 29/08

(52) U.S. Cl. CPC G06Q 30/0617; H04L 67/306; H04L 67/22

(57) ABSTRACT

Disclosed herein are virtual assistant methods, systems, and devices to identify users in need of guidance and to provide the guidance in response to identifying the need. Consistent with some embodiments, a method includes receiving, at a virtual assistant device, user input associated with a user profile and identifying an item category corresponding to user input. The method further includes detecting an anomalous relationship between the user profile and the item category based on user activity associated with the user profile. The method further includes causing the virtual assistant device to provide guidance with respect to the item category in response to detecting the anomalous relationship. The guidance includes presenting guidance information comprising attribute values of at least one item from the item category. The attribute values correspond to attributes of interest determined from additional user input.

### TECHNICAL FIELD

The subject matter disclosed herein generally relates to virtual assistants. Specifically, in some example embodiments, the present disclosure addresses systems, methods, and devices to provide a virtual assistant configured to provide guidance based on item category familiarity.

### BACKGROUND

In the context of shopping with a conventional virtual assistant device (e.g., Amazon Echo® or Google Home®), paradoxically when a user is experiencing difficulties in researching and deciding which product to purchase and is in most need of assistance, the device may be unable to determine from voice commands alone when the user is in need of shopping guidance given the limited number of recognized input signals as compared to a full browser based shopping session. Further, given that the interactions with the user may be limited to brief verbal exchanges, the device may be unable to provide any sort of meaningful shopping guidance to the user without requiring the user to engage in a lengthy and time consuming back and forth process.

### BRIEF DESCRIPTION OF THE DRAWINGS

Some embodiments are illustrated by way of example and not limitation in the figures of the accompanying drawings.

FIG. 1 shows a network system, according to some example embodiments.

FIG. 2 shows a general architecture of a virtual assistant system, according to some example embodiments.

FIG. 3 shows components of a speech recognition component, according to some example embodiments.

FIG. 4 shows an overview of the virtual assistant system processing natural language user inputs to provide guidance with respect to an item category in an electronic marketplace, according to some example embodiments.

FIG. 5 shows a natural language understanding (NLU) component, its sub-components, and other components with which it interacts, according to some example embodiments.

FIGS. 6-9 are flowcharts illustrating operations of the virtual assistant system in performing a method for providing shopping guidance, according to an example embodiment.

FIG. 10 shows components of a machine, according to some example embodiments, able to read instructions from a machine-readable medium (e.g., a computer-readable storage medium) and perform any one or more of the methodologies discussed herein.

FIG. 11 shows a representative software architecture software architecture, which may be used in conjunction with various hardware architectures described herein.

### DETAILED DESCRIPTION

Example methods, systems, and devices are directed to providing automated item guidance based on item category familiarity. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

As noted above, conventional virtual assistant devices may be unable to determine when a user needs shopping guidance given the limited number of signals available to the device as compared to a full browser based shopping session. Further, these conventional virtual assistant devices may be unable to provide any sort of meaningful shopping guidance to the user without requiring the user to engage in a lengthy and time consuming back and forth process.

Aspects of the present disclosure address the above referenced issues among others with methods, systems, and devices configured to identify users in need of shopping guidance and to provide the guidance in response to identifying the need. Consistent with some embodiments, a method includes identifying an item category corresponding to user input received at a virtual assistant device and determining the user has limited familiarity with the item category based on user activity including previous transactions (e.g., sales and purchases) and browsing behavior. Upon determining the user has limited familiarity with the item category, the virtual assistant device provides shopping guidance. The shopping guidance may include prompting the user to provide additional input to aid the virtual assistant device to identify an intent of the user with respect to the item category and identify item attributes that are important to the user.

In some embodiments, the shopping guidance further includes providing the user with recommendations for items within the category based on the identified intent and item attributes. In presenting the user with the recommended items, the virtual assistant device presents information about the items including attribute values corresponding to the identified item attributes. In some instances, item review ratings may also be provided.

In some embodiments, the shopping guidance further includes identifying an expert user with expertise in the item category and communicatively connecting the user of the virtual assistant device to the expert user. Prior to communicatively connecting the users, the virtual assistant device or another component in a virtual assistant system may provide the expert user with the item category, along with the intent and item attributes of the user of the virtual assistant device, to aid the expert user in providing further guidance to the user of the virtual assistant device.

Technical solutions provided by the present inventive subject matter allow users to communicate with a virtual assistant device in a natural conversation. The virtual assistant is efficient because over time it increasingly understands specific user preferences and needs and is knowledgeable about a wide range of products. Though a variety of convenient input modalities, a user can use voice or text, and the assisted user experience may be akin to talking to a trusted, knowledgeable human shopping assistant in a high-end store, for example.

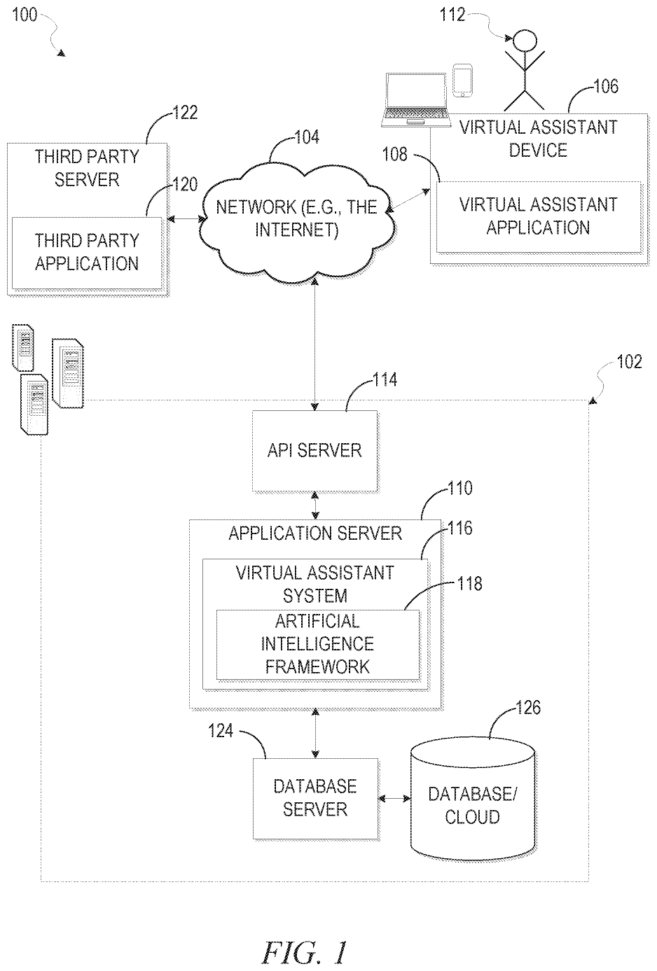

With reference to FIG. 1, an example embodiment of a network architecture 100 is shown. A network system 102 provides server-side functionality via a network 104 (e.g., the Internet or wide area network (WAN)) to a virtual assistant device 106. A programmatic client, in the example form of a virtual assistant application 108, is hosted and executes on the virtual assistant device 106. The network system 102 includes and application server 110, which in turn hosts a virtual assistant system 116 that provides a number of functions and services to the virtual assistant application 108 that accesses the network system 102.

Also shown in FIG. 1 is a user 112. The user 112 may be a human user (e.g., a human being), a machine user (e.g., a computer configured by a software program to interact with the virtual assistant device 106 and the application server 110), or any suitable combination thereof (e.g., a human assisted by a machine or a machine supervised by a human). The user 112 is not part of the network architecture 100, but is associated with the virtual assistant device 106 and may be a user of the virtual assistant device 106.

The virtual assistant device 106 enables the user 112 to access and interact with the network system 102. For instance, the user 112 may provide input (e.g., voice input) to the virtual assistant device 106, and the input is communicated to the network system 102 via the network 104. In this instance, the network system 102, in response to receiving the input from the user, communicates information back to the virtual assistant device 106 via the network 104 to be presented to the user.

An Application Program Interface (API) server 114 is coupled to, and provides programmatic interfaces to, the application server 110. The application server 110 hosts a virtual assistant system 116 that includes an AI (AI) framework 118 among other components and applications. The application server 110 is, in turn, shown to be coupled to a database server 124 that facilitates access to information storage repositories (e.g., a database/cloud 126). In an example embodiment, the database/cloud 126 includes storage devices that store information accessed and generated by the virtual assistant system 116. As used herein, a “database” is a data storage resource and may store data structured as a text file, a table, a spreadsheet, a relational database (e.g., an object-relational database), a triple store, a hierarchical data store, or any suitable combination thereof.

The virtual assistant application 108 accesses the various services and functions provided by the virtual assistant system 116 via the programmatic interface provided by the API server 114. In some embodiments, the virtual assistant device 106 is a voice controlled speaker device (e.g., Amazon Echo® or Google Home®) or other such device, and the virtual assistant application 108 may configure the device to enable the user 112 to interact with the network system 102 using verbal input modalities. In some embodiments, the virtual assistant device 106 may be a mobile computing device such as a smart phone or tablet, a laptop computer, or desktop computer; and the virtual assistant application 108 may be, for example, an “app” executing on a virtual assistant device 106, such as an iOS or Android OS application to enable the user 112 to interact with the network system 102 using a variety of input modalities including verbal, text, and image.

Additionally, a third-party application 120, executing on a third-party server 122, is shown as having programmatic access to the network system 102 via the programmatic interface provided by the API server 114. For example, the third-party application 120, using information retrieved from the network system 102, may support one or more features or functions on a website hosted by the third-party.

While the network architecture 100 shown in FIG. 1 employs a client-server architecture, the present inventive subject matter is of course not limited to such an architecture, and could equally well find application in a distributed, or peer-to-peer, architecture system, for example. The virtual assistant system 116 could also be implemented as a standalone software program, which does not necessarily have networking capabilities. Further, any two or more of the machines, databases, or devices illustrated in FIG. 1 may be combined into a single machine, database, or device, and the functions described herein for any single machine, database, or device may be subdivided among multiple machines, databases, or devices.

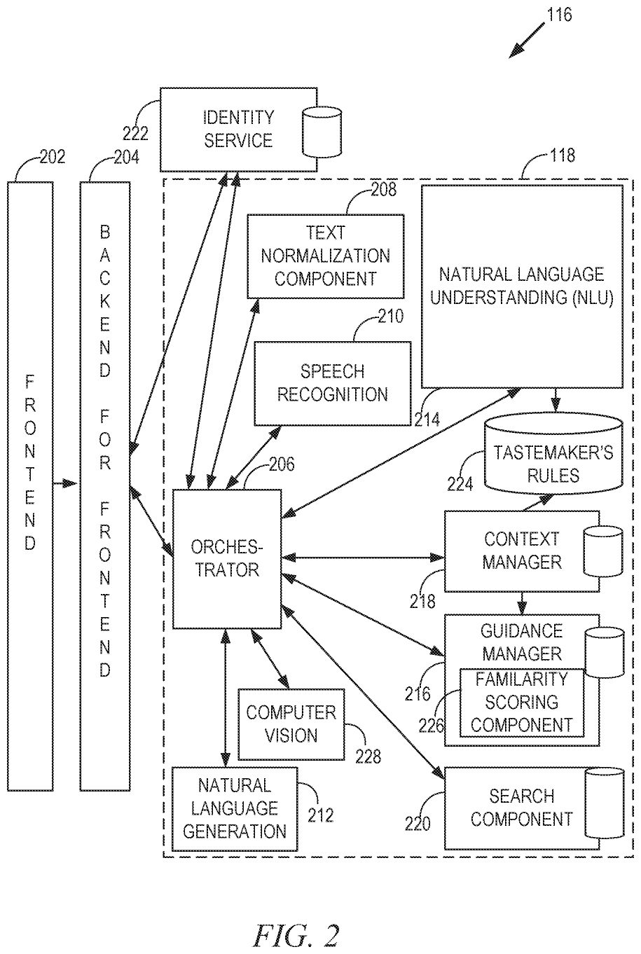

FIG. 2 is a block diagram showing the general architecture of a virtual assistant system 116, according to some example embodiments. Specifically, the virtual assistant system 116 is shown to include a front-end component 202 by which the virtual assistant system 116 communicates (e.g., over the network 104) with other systems within the network architecture 100. The front-end component 202 can communicate with the messaging fabric of existing messaging systems. As used herein, the term “messaging fabric” refers to a collection of APIs and services that can power third-party platforms such as Facebook messenger, Microsoft Cortana, and other “bots.” In one example, a messaging fabric can support an online commerce ecosystem that allows users to interact with commercial intent. In some embodiments such as virtual assistant device implementations, output of the front-end component 202 can be presented as audio output at a speaker of the virtual assistant device 106 as part of interactions with a virtual assistant. In other embodiments, output of the front-end component 202 can be rendered on a display of the virtual assistant device 106 as part of a graphical interface with a virtual assistant, or “bot.”

The front-end component 202 of the virtual assistant system 116 is coupled to a back-end component 204 that operates to link the front-end component 202 with the AI framework 118. The AI framework 118 may include several components as discussed below. The data exchanged between various components and the function of each component may vary to some extent, depending on the particular implementation.

In one example of the virtual assistant system 116, an AI orchestrator 206 orchestrates communication between components inside and outside the AI framework 118. Input modalities for the AI orchestrator 206 may be derived from a computer vision component 228, a speech recognition component 210 and a text normalization component 208, which may form part of the speech recognition component 210, for example. The computer vision component 228 may identify objects and attributes from visual input (e.g., a photo). Thus, key functionalities of the computer vision component 228 may include object localization, object recognition, optical character recognition (OCR) and matching against inventory based on visual cues from an image or video. The speech recognition component 210 may convert audio signals (e.g., spoken utterances) into text. The text normalization component 208 may operate to make input normalization, such as language normalization by rendering emoticons into text, for example. Other normalization is possible such as orthographic normalization, foreign language normalization, conversational text normalization, and so forth. For convenience, all user inputs in this description may be referred to as “utterances,” whether in text, voice, or image-related formats.

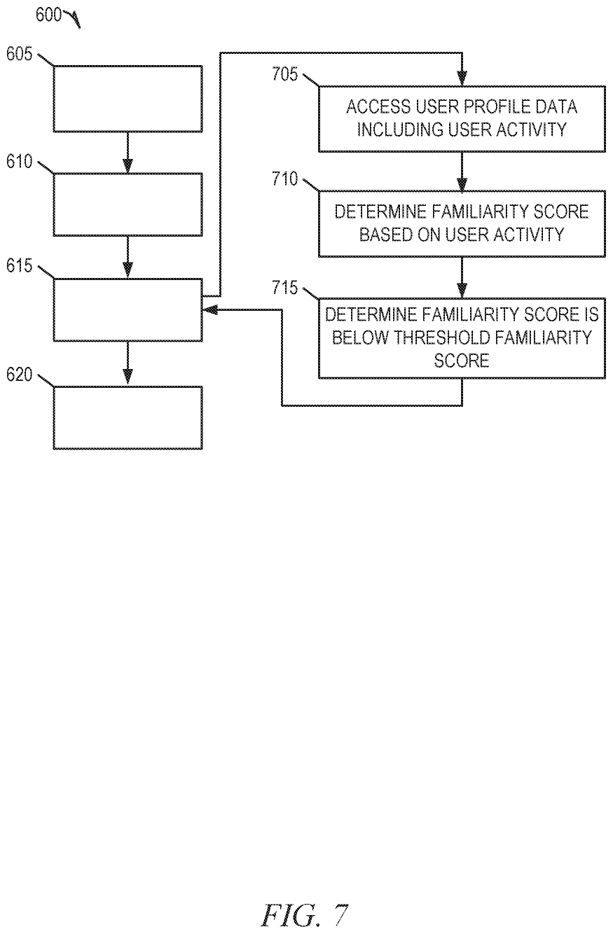

The AI framework 118 further includes a NLU component 214 that operates to determine a dominant object of user input to determine user intent, and to identify various intent parameters including item attributes of interest. The dominant object may, for example, include an item category, a group of categories, an item sub-category, or groups of sub-categories. The NLU component 214 is described in further detail beginning with FIG. 7.

The AI framework 118 further includes a guidance manager 216 that operates to determine whether the user 112 needs guidance based on a familiarity of the user 112 with the dominant object of the user input (e.g., the item category) identified by the NLU component 214. To this end, the guidance manager 216 is configured to detect an anomalous relationship between a user profile of the user 112 and the dominant object of the user input. Accordingly, the guidance manager 216 includes a familiarity scoring component 226 to generate a familiarity score that provides a measure of familiarity associated with the user profile with respect to the dominant object of user input. If the guidance manager 216 determines the familiarity score is below a threshold familiarity score, the guidance manager 216 determines that an anomalous relationship exists between the user profile of the user 112 and the dominant object of the user input, and in response, the guidance manager 216 works in conjunction with the other components of the virtual assistant system 116 to provide guidance to the user 112 at the virtual assistant device 106. In working to provide guidance to the user 112, the guidance manager 216 also operates to understand a “completeness of specificity” of user input and decide on a next action type and a related parameter (e.g., “search” or “request further information from user”).

In one example, the guidance manager 216 operates in association with the NLU component 214, a context manager 218, and a Natural Language Generation (NLG) component 212. In another example, the guidance manager 216 has the NLU component 214, the context manager 218, and the NLG component 212 as sub-components.

The context manager 218 manages the context and communication of the user 112 with respect to the virtual assistant device 106. The context manager 218 retains a short term history of user interactions. A longer term history of user preferences may be retained in an identity service 222, described below. Data entries in one or both of these histories may include the relevant intent, all parameters, and all related results of a given input, bot interaction, or turn of communication, for example. The NLG component 212 operates to compose a natural language utterance out of an AI message to present to the user 112 at the virtual assistant device 106.

A search component 220 is also included within the AI framework 118. The search component 220 may have front and back-end units. The back-end unit may operate to manage item or product inventory and provide functions of searching against the inventory. The search component 220 can accommodate text or AI encoded voice and image inputs, and identify relevant inventory items to users based on explicit and derived query intents.

An identity service 222 component operates to manage user profiles (for example, explicit information in the form of user attributes, e.g., “name,” “age,” “gender,” “geolocation,” and also implicit information in forms such as “information distillates” such as “user interest,” or “similar persona,” and so forth. The AI framework 118 may comprise part of, or operate in association with, the identity service 222. The identity service 222 includes a set of policies, APIs, and services that elegantly centralizes all user information, helping the AI framework 118 to have “intelligent” insights into user intent. The identity service 222 can protect online retailers and users from fraud or malicious use of private information.

The identity service 222 of the present disclosure provides many advantages. The identity service 222 is a single central repository containing user identity and profile data. It may continuously enrich the user profile with new insights and updates. It uses account linking and identity federation to map relationships of a user with a company, household, other accounts (e.g., core account), as well as a user's social graph of people and relationships.

In one example, the identity service 222 concentrates on unifying as much user information as possible in a central clearinghouse for search, AI, merchandising, and machine learning models to maximize each component's capability to deliver insights to each user. A single central repository contains user identity and profile data in a meticulously detailed schema. In an onboarding phase, the identity service 222 primes a user profile and understanding by mandatory authentication. Any public information available from the source of authentication (e.g., social media) may be loaded. In sideboarding phases, the identity service 222 may augment the profile with information about the user that is gathered from public sources, user behaviors, interactions, and the explicit set of purposes the user tells the AI (e.g., shopping missions, inspirations, preferences). As the user interacts with the AI framework 118, the identity service 222 gathers and infers more about the user and stores the explicit data, derived information, and updates probabilities and estimations of other statistical inferences. Over time, in profile enrichment phases, the identity service 222 also mines behavioral data such as clicks, impressions, and browse activities for derived information such as tastes, preferences, and shopping verticals. In identity federation and account linking phases, when communicated or inferred, the identity service 222 updates the user's household, employer, groups, affiliations, social graph, and other accounts, including shared accounts.

The functionalities of the AI framework 118 can be grouped into multiple parts (for example, decisioning and context parts). In one example, the decisioning part includes operations by the AI orchestrator 206, the NLU component 214, the guidance manager 216, the NLG component 212, the computer vision component 228, and speech recognition component 210. The context part of the AI functionality relates to the parameters (implicit and explicit) around a user and the communicated intent (for example, towards a given inventory, or otherwise). In order to measure and improve AI quality over time, the AI framework 118 may be trained using sample queries (e.g., a development set) and tested on a different set of queries (e.g., an evaluation set), where both sets may be developed by human curation. Also, the AI framework 118 may be trained on transaction and interaction flows defined by experienced curation specialists or human tastemaker override rules 224. The flows and the logic encoded within the various components of the AI framework 118 define what follow-up utterance or presentation (e.g., question, result set) is made by the intelligent assistant based on an identified user intent.

Reference is made further above to example input modalities of the virtual assistant system 116. The virtual assistant system 116 seeks to understand a user's intent and other parameters (e.g., item category, item attributes of interest, and so forth) as well as implicit information (e.g., geolocation, personal preferences, age, and gender, and so forth) and respond to the user with guidance related to the user's intent. Explicit input modalities may include text, speech, and visual input and can be enriched with implicit knowledge of user (e.g., geolocation, previous browse history, and so forth). Output modalities can include text (such as natural language sentences), product-relevant information, images on the screen of a smart device, and audio (e.g., speech).

In an ecommerce example, the virtual assistant system 116 may leverage enormous sets of ecommerce data. Some of this data may be retained in proprietary databases or in the cloud (e.g., database/cloud 126). Statistics and other information about this data may be communicated to guidance manager 216 from the search component 220 as context. The AI framework 118 may act directly upon utterances from the user, which may be run through speech recognition component 210, then the NLU component 214, and then passed to context manager 218 as semi-parsed data. The NLG component 212 may thus help the guidance manager 216 generate human-like questions and responses in text or speech to the user 112. The context manager 218 maintains the coherency of multi-turn and long term discourse between the user 112 and the AI framework 118.

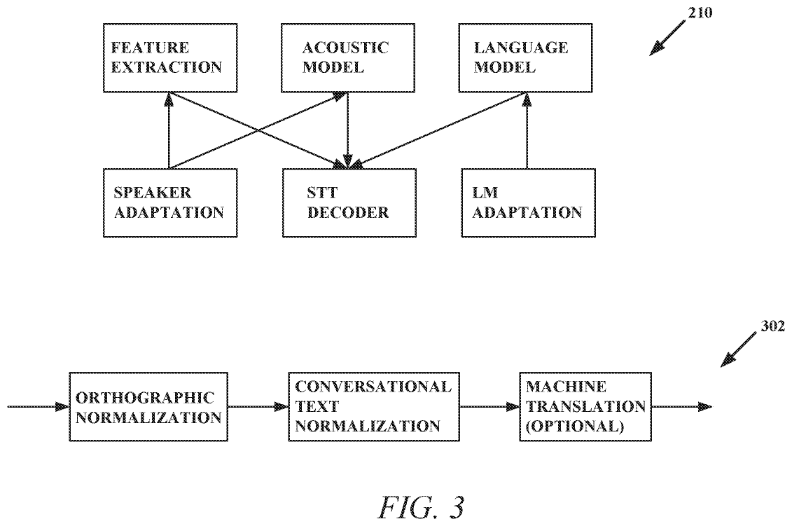

With reference to FIG. 3, the illustrated components of the speech recognition component 210 are now described. A feature extraction component operates to convert raw audio waveform to a some-dimensional vector of numbers that represents the sound. This component uses deep learning to project the raw signal into a high-dimensional semantic space. An acoustic model component operates to host a statistical model of speech units, such as phonemes and allophones. These can include Gaussian Mixture Models (GMM), although the use of Deep Neural Networks is possible. A language model component uses statistical models of grammar to define how words are put together in a sentence. Such models can include n-gram-based models or Deep Neural Networks built on top of word embeddings. A speech-to-text (STT) decoder component may convert a speech utterance into a sequence of words typically by leveraging features derived from a raw signal using the feature extraction component, the acoustic model component, and the language model component in a Hidden Markov Model (HMM) framework to derive word sequences from feature sequences. In one example, a speech-to-text service in the cloud (e.g., database/cloud 126) has these components deployed in a cloud framework with an API that allows audio samples to be posted for speech utterances and to retrieve the corresponding word sequence. Control parameters are available to customize or influence the speech-to-text process.

In one example of the AI framework 118, two additional parts for the speech recognition component 210 are provided: a speaker adaptation component and a Language Model (LM) adaptation component. The speaker adaptation component allows clients of an STT system (e.g., speech recognition component 210) to customize the feature extraction component and/or the acoustic model component for each speaker/user. This can be important because most speech-to-text systems are trained on data from a representative set of speakers from a target region and typically the accuracy of the system depends heavily on how well the target speaker matches the speakers in the training pool. The speaker adaptation component allows the speech recognition component 210 (and consequently the AI framework 118) to be robust to speaker variations by continuously learning the idiosyncrasies of a user's intonation, pronunciation, accent, and other speech factors, and apply these to the speech-dependent components. While this approach may require a small voice profile to be created and persisted for each speaker, the potential benefits of accuracy generally far outweigh the storage drawbacks.

The LM adaptation component operates to customize the language model component and the speech-to-text vocabulary with new words and representative sentences from a target domain (for example, inventory categories or user personas). This capability allows the AI framework 118 to be scalable as new categories and personas are supported.

FIG. 3 also shows a flow sequence 302 for text normalization in an AI framework 118. A text normalization component 208 performing the flow sequence 302 is included in the speech recognition component 210 in one example. Key functionalities in the flow sequence 302 include orthographic normalization (to handle punctuation, numbers, case, and so forth), conversational text normalization (to handle informal chat-type text with acronyms, abbreviations, incomplete fragments, slang, and so forth), and machine translation (to convert a normalized sequence of foreign-language words into a sequence of words in an operating language, including but not limited to English, for example).

The AI framework 118 facilitates modern communications. The technical ability of the AI framework 118 to use multiple modalities allows the communication of intent instead of just text. The AI framework 118 provides technical solutions and is efficient. It is faster to interact with a smart personal assistant using voice commands or photos than text in many instances.

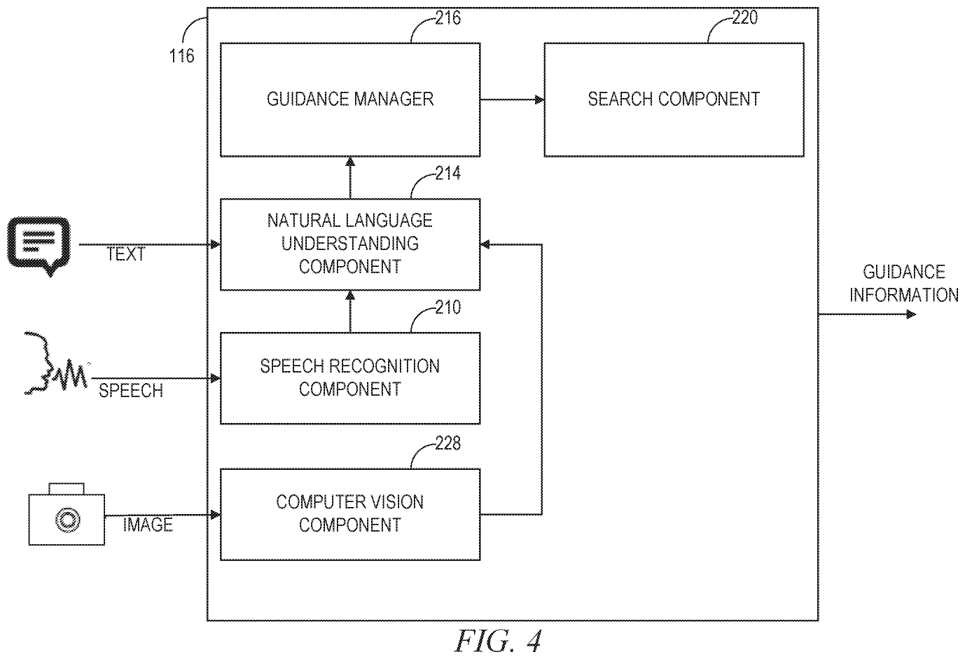

FIG. 4 shows an overview of the virtual assistant system 116 processing natural language user inputs to provide guidance with respect to an item category in an electronic marketplace. Although the virtual assistant system 116 is not limited to this use scenario, it may be of particular utility in this situation. As previously described, any combination of text, image, and voice data may be received by the AI framework 118. Image data may be processed by the computer vision component 228 to provide image attribute data. Voice data may be processed by the speech recognition component 210 into text.

All of these inputs and others may be provided to the NLU component 214 for analysis. The NLU component 214 may operate to parse user inputs to determine an item category associated with a received utterance, user intent, and intent-related parameters such as item attributes of interest. For example, the NLU component 214 may discern the dominant object of user interest such as an item category, a variety of attributes of interest, and possibly attribute values related to that dominant object. The NLU component 214 may provide extracted data to the guidance manager 216, as well as the AI orchestrator 206 previously shown.

The NLU component 214 may generally transform formal and informal natural language user inputs into a more formal, machine-readable, structured representation of a user input. That formalized query may be enhanced further by the guidance manager 216. In one scenario, the NLU component 214 processes a sequence of user inputs including an initial utterance (e.g., a query) and further data provided by a user in response to machine-generated prompts from the guidance manager 216 in a multi-turn interactive dialog. This user-machine interaction may improve the efficiency and accuracy of one or more automated searches for the items available for purchase in an electronic marketplace. The searches may be performed by the search component 220.

Upon determining a user needs guidance based on an anomalous relationship between the user profile and the dominant object of the user input (e.g., an item category), the guidance manager 216 may work in conjunction with the NLU component 214 to determine a user intent with respect to the dominant object to determine what further action is needed in terms of providing guidance to the user 112. In one ecommerce-related example, at the very highest level, user intent could be shopping, browsing, or product comparison. If the user intent is shopping, it could relate to the pursuit of an item to purchase for a specific purpose or intended use. Once the high level intent is identified, the AI framework 118 is tasked with determining what the user is looking for; that is, is the need broad (e.g., shoes, dresses) or more specific (e.g., Size 10 Nike running shoes) or somewhere in between (e.g., black sneakers).

In a novel and distinct improvement over the prior art in this field, the AI framework 118 may map user input to certain primary dimensions, such as categories, attributes, and attribute values. This enables the virtual assistant system 116 to engage with the user 112 to refine a set of search constraints to be used in identifying items for recommendation to the user 112 as part of the guidance provided to the user 112. Further, over time, machine learning may add deeper semantics and wider “world knowledge” to the system, in order to better understand the user intent. For example, the input “I am looking for a dress for a wedding in June in Italy” means the dress should be appropriate for particular weather conditions at a given time and place and should be appropriate for a formal occasion.

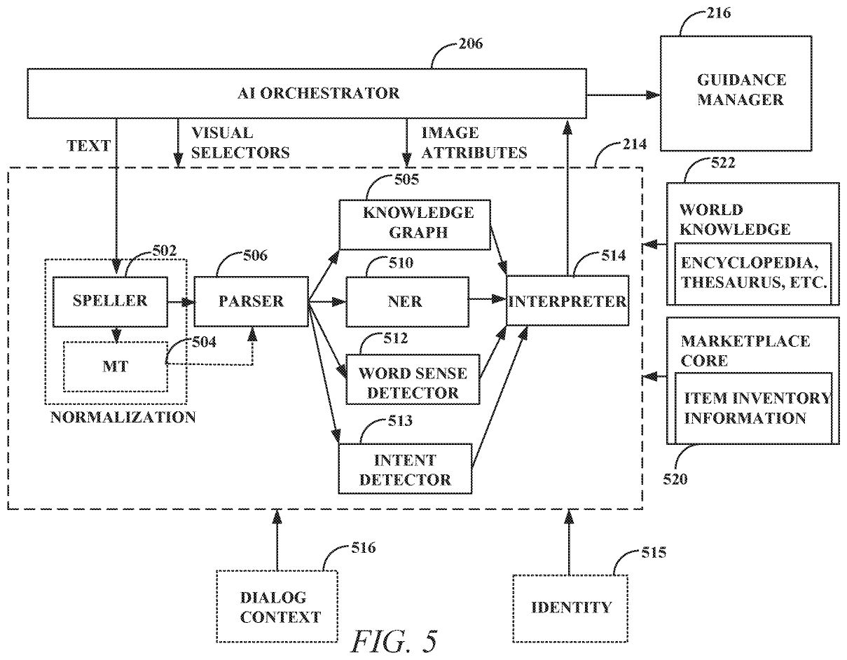

FIG. 5 shows the NLU component 214, its sub-components, and other components with which it interacts, according to some example embodiments. In some embodiments, extracting a user intent is performed by the NLU component 214 by breaking down this often complex technical problem into multiple parts. Each of the various parts of the overall problem of extracting user intent may be processed by particular sub-components of the NLU component 214, sometimes separately and sometimes in combination.

The sub-components may, for example, comprise a spelling corrector (speller) 502, a machine translator (MT) 504, a parser 506, a knowledge graph 505, a Named Entity Recognition (NER) sub-component 510, a Word Sense Detector (WSD) 512, an intent detector 513, and an interpreter 514. The NLU component 214 may receive audio, text, and other inputs, e.g., via the AI orchestrator 206 in one embodiment, and process each separately or in combination. The NLU component 214 may provide its various outputs, to be described, to the AI orchestrator 206 in one embodiment, to be distributed to other components of the AI framework 118, such as the guidance manager 216.

Other inputs considered by the NLU component 214 may include dialog context 516 (e.g., from context manager 218), user identity information 515 (e.g., from identity service 222), item inventory-related information 520 (e.g., from the core search component 220 functions of an electronic marketplace), and external world knowledge 522 to improve the semantic inference of user intent from user input. Different types of analyses of these inputs may each yield results that may be interpreted in aggregate and coordinated via the knowledge graph 505. The knowledge graph 505 may for example be based on past users' interactions, inventory-related data, or both.

The knowledge graph 505 is generally a database or file that represents a plurality of nodes. Each node may represent an item category, an item attribute, or an item attribute value for the exemplary scenario of processing natural language user inputs to provide guidance. Nodes within the knowledge graph 505 may be linked by directed edges that may have an associated correlation or association value indicating a strength of a relationship between two particular nodes. In an example, item categories include “Men's Athletic Shoes,” “Cars & Trucks,” and “Women's Athletic Shoes,” and item attributes include “Product Line,” “Brand,” “Color,” and “Style.”. To further this example, item attribute values may include “Air Jordan,” “Kobe Bryant,” “Air Force 1,” “Asics,” “Nike,” “New Balance,” “Adidas,” “Blue,” “White,” “Red,” “Black,” “Metallic Black,” “Running,” “Basketball,” and “Sneakers.”. Item attributes are often directly linked to item categories, although that is not always the case. The item attribute values are often directly linked to item attributes, although again that is not always the case.

The speller 502 may identify and correct spelling mistakes in user-entered text. User text may include, but is not limited to, user queries and item titles. The MT 504 may optionally translate user input from the user's natural language into an operating language, including but not limited to English for example. The speller 502 and the MT 504 may also coordinate with other normalization sub-components and/or the parser 506 to process abbreviations, acronyms, and slang into more formal data for improved analysis.

The parser (or dependency parser) 506 may help detect the user's intent by identifying a dominant object of the user's input, such as an item category, based on one or more terms included as part of the user's input. For example, this process may involve the parser 506 identifying and analyzing noun-phrases including prepositions and direct and indirect objects, verbs, and affirmations and negations in user input such as from a multi-turn dialog. Affirmations and negations may be detected in the intent detector 513 in some embodiments, or by different sub-components such as the word sense detector 512. The terms identified by the parser 506 may be mapped to one of multiple item categories (e.g., described by or included in the item inventory-related information 520).

In one embodiment, the parser 506 finds the dominant object of user interest from the longest fragment of the user input that can be fully resolved. The parser 506 may also discard user input terms that are of low content, such as “Hi there” and “Can you help me” and so forth, and/or replace them with less machine-confusing phrases. The parser 506 may also recognize various occasions (e.g., weddings, Mother's Day, and so forth).

The intent detector 513 may further refine the identification of the user intent by identifying an item category corresponding to the dominant object (if the dominant object is not itself an item category) and attributes of interest for the item category. For example, the knowledge graph 505 may specify dominant item categories in a given item inventory (e.g., an eBay inventory, or database/cloud 126), and if the dominant object identified by the parser 506 is a specific item, the intent detector 513 may use the knowledge graph 505 to map the specific item to a dominant category for that item. The knowledge graph 505 may also use dominant (e.g., most frequently user-queried or most frequently occurring in an item inventory) attributes pertaining to that item category and the dominant values for those attributes. Thus, for any given item category, the intent detector 513 may use the knowledge graph 505 to identify dominant attributes for the item category and dominant values for those attributes as these may be attributes and attribute values of interest to the user. The NLU component 214 may provide as its output the dominant object, user intent, and the knowledge graph 505 that is formulated along dimensions likely to be relevant to the user input. This information may help the guidance manager 216 if there is missing information needed to identify items for the user as part of providing guidance, and whether (and how) to prompt the user to further refine the user's requirements via additional input.

The background information for the knowledge graph 505 may be extracted from the item inventory as a blend of information derived from a hand-curated catalog as well as information extracted from historical user behavior (e.g., a history of all previous user interactions with an electronic marketplace over a period of time). The knowledge graph 505 may also include world knowledge extracted from outside sources, such as internet encyclopedias (e.g., Wikipedia), online dictionaries, thesauruses, and lexical databases (e.g., WordNet). For example, data regarding term similarities and relationships may be available to determine that the terms girl, daughter, sister, woman, aunt, niece, grandmother, and mother all refer to female persons and different specific relative familial relationships. These additional associations may clarify the meaning or meanings of user query terms and help prevent generation of prompts that may educate the bot but annoy the user. Focus group studies have shown that some users do not want to provide more than a predetermined number (e.g., three) of replies to prompts, so each of those prompts should be as incisive as possible.

The knowledge graph 505 may be updated dynamically in some embodiments (for example, by the AI orchestrator 206). That is, if the item inventory changes or if new user behaviors or new world knowledge data have led to successful user searches, the virtual assistant system 116 is able to take advantage of those changes for future user searches. An assistant that learns may foster further user interaction, particularly for those users who are less inclined toward extensive conversations. Embodiments may therefore modify the knowledge graph 505 to adjust the information it contains and shares both with other sub-components within the NLU component 214 and externally (e.g. with the guidance manager 216).

The NER sub-component 510 may extract deeper information from parsed user input (e.g., brand names, size information, colors, and other descriptors) and help transform the user natural language input into a structured query comprising such parsed data elements. The NER sub-component 510 may also tap into world knowledge to help resolve meaning for extracted terms. For example, a query for “a bordeaux” may more successfully determine from an online dictionary and encyclopedia that the query term may refer to an item category (wine), attributes (type, color, origin location), and respective corresponding attribute values (Bordeaux, red, France). Similarly, a place name (e.g., Lake Tahoe) may correspond to a given geographic location, weather data, cultural information, relative costs, and popular activities that may help a user find a relevant item. The structured query depth (e.g., number of tags resolved for a given user utterance length) may help the guidance manager 216 select what further action it should take to improve a ranking in a search performed by the search component 220.

The word sense detector 512 may process words that are polysemous, that is, have multiple meanings that differ based on the context. For example, the input term “bank” could refer to an “edge of a river” in a geographic sense or a “financial institution” in a purchase transaction payment sense. The Word Sense Detector 512 detects such words and may trigger the guidance manager 216 to seek further resolution from a user if a word sense remains ambiguous. The Word Sense Detector 512 or the intent detector 513 may also discern affirmations and negations from exemplary phrases including but not limited to “Show me more” or “No, I don't like that,” respectively, and so forth. The functions of the parser 506, the intent detector 513, and the Word Sense Detector 512 may therefore overlap or interact to some extent, depending on the particular implementation.

The interpreter 814 reconciles the analyzed information coming from the various NLU sub-components and prepares output. The output may, for example, comprise a dominant object of a user query, as well as information resolved regarding relevant knowledge graph dimensions (e.g., item categories, item attributes, item attribute values), the user's intent (e.g., in the case of shopping, whether shopping for a specific item, looking for a gift, or general browsing), a type of user statement recognized, the intended target item recipient, and so forth. Through the combination of separate analyses performed on shared, augmented, and processed user inputs, the components of the AI framework 118 provide a trusted personal shopper (bot) that both understands user intent and is knowledgeable about a wide range of products. The NLU component 214 thus transforms a natural language user input into a structured query to help provide guidance to a user with respect to a particular item category with which the user may be unfamiliar.

The NLU component 214 therefore improves the operation of the virtual assistant system 116 overall by reducing mistakes, increasing the likelihood of correct divination of user intent underlying user input, and yielding faster and better targeted searches and item recommendations. The NLU component 214, particularly together with the guidance manager 216 in multi-turn dialog scenarios, effectively governs the operation of the search component 220 by providing more user interaction history-focused and/or item inventory-focused search queries to execute. This distinctive functionality goes beyond the current state of the art via a particular ordered combination of elements as described.

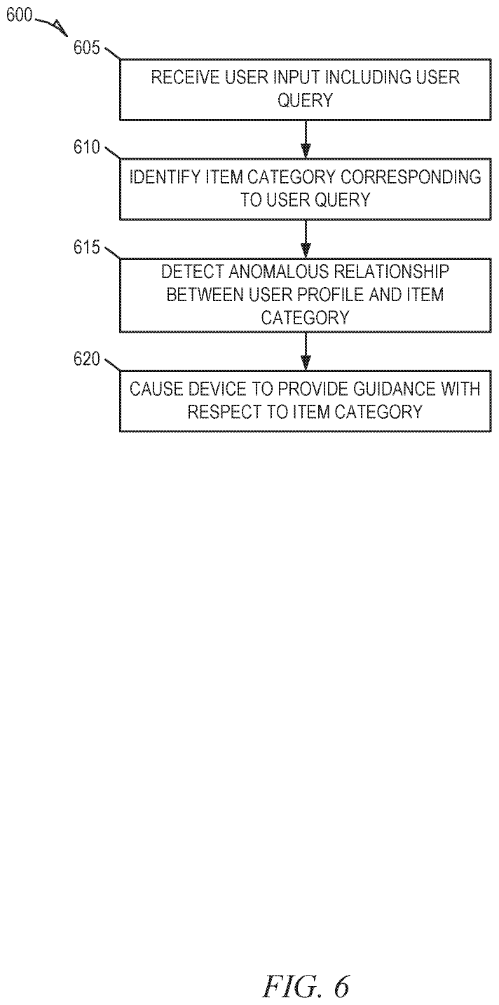

FIGS. 6-9 are flowcharts illustrating operations of the virtual assistant system in performing a method 600 for providing automated shopping guidance, according to an example embodiment. The method 600 may be embodied in computer-readable instructions for execution by one or more processors, such that the operations of the method 600 may be performed in part or in whole by components of the virtual assistant system 116; accordingly, the method 600 is described below by way of example with reference thereto. However, it shall be appreciated that at least some of the operations of the method 600 may be deployed on various other hardware configurations and the method 600 is not intended to be limited to the network system 102.

At operation 605, the virtual assistant system 116 receives user input associated with a user profile. The user input comprises a user query. Upon receiving the user input, the identity service 222 may identify the user profile to which user input is associated by identifying the user profile of a user who provided the user input.

At operation 610, the NLU component 214 identifies an item category corresponding to the user query based on one or more terms included in the user query. The item category may be the dominant object of the user query, as discussed above. The NLU component 214 may, for example, identity the item category corresponding to the user query by parsing the user query to identify noun-phrases, objects, verbs, and affirmations and negations in the query, and mapping one or more of these terms to one of multiple item categories in a given item inventory (e.g., an eBay inventory, or database/cloud 126).

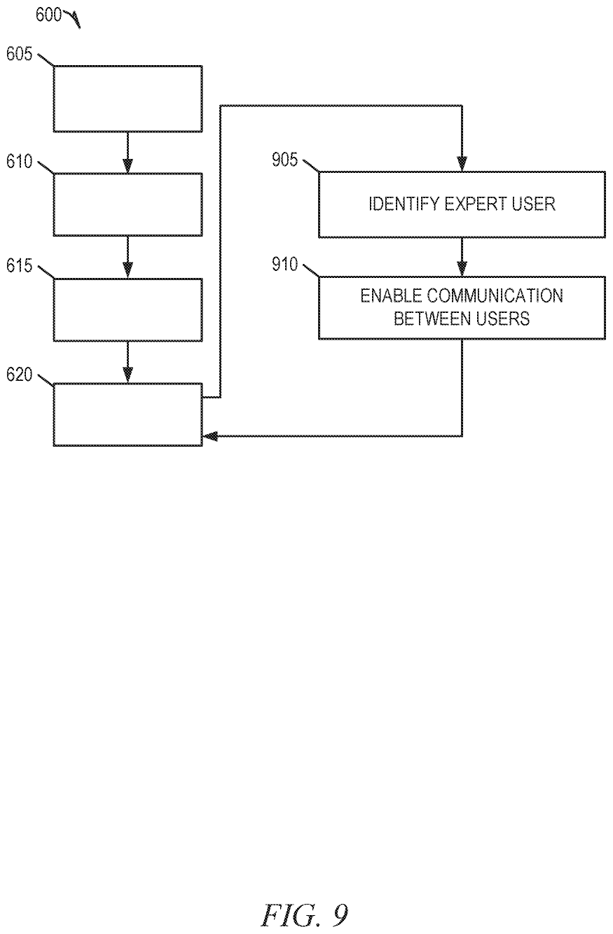

At operation 615, the guidance manager 216 detects an anomalous relationship between the user profile and the item category based on user activity associated with the user profile. The detecting of the anomalous relationship between the user profile and the item category may include generating a familiarity score with respect to the item category based on the user activity and determining that the familiarity score is below a threshold familiarity score. The familiarity score may be based on a number and type of actions in the user activity associated with the item category. Further details regarding the detecting of the anomalous relationship between the user profile and the item category are discussed below in reference to FIG. 9.

Based on detecting the anomalous relationship between the user profile and the item category, the guidance manager 216 determines the user is unfamiliar with the item category and is thus in need of guidance with respect to the item category. Accordingly, the guidance manager 216, at operation 620, causes the virtual assistant device 106 to provide guidance with respect to the item category in response to detecting the anomalous relationship between the user profile and the item category. In providing the guidance with respect to the item category, the virtual assistant device 106 may prompt the user for additional user input, and the NLU component 214 may determine, from the additional user input, a user intent with respect to the item category, which may include determining one or more item attributes of interest along with one or more values for these attributes.

In some embodiments, the providing of the guidance with respect to the item category may further include presenting guidance information that includes one or more attribute values of at least one item in the item category. The one or more attribute values correspond to the one or more attributes of interest with respect to the item category. The guidance information may further include an overall rating for the at least one item. The overall rating may, for example, be determined based on one or more user reviews for the at least one item.

In some embodiments, the presenting of the guidance with respect to the item category may further include communicatively connecting the user of the virtual assistant device 106 with an expert user having expertise with the item category (e.g., determined based on user activity of the expert user).

It shall be appreciated that although the method 600 is described above in reference to providing item guidance with respect to a single item category, the method 600 is not limited in applicability to a single item category, and may be applied to groups of item categories, an item sub-category, or groups of sub-categories. For example, in some embodiments, the method 600 may include identifying an item sub-category, a group of item categories, or a group of item sub-categories from the user query, detecting an anomalous relationship between the user profile and the item sub-category, the group of item categories, or the group of item subcategories, and providing guidance with respect to the item sub-category, the group of item categories, or the group of item subcategories in response thereto.

As shown in FIG. 7, the method 600 may, in some embodiments, further include operations 705, 710, and 715. Consistent with some embodiments, the operations 705, 710, and 715 may be performed as part of (e.g., as sub-operations or as a subroutine) operation 615, where the guidance manager 216 detects the anomalous relationship between the user profile and the item category.

At operation 705, the familiarity scoring component 226 accesses user profile data associated with the user profile. The user profile data includes information that describes user activity associated with the user profile. The user activity includes one or more actions performed by the user corresponding to the user profile. As an example, the one or more actions performed by the user may include interactions with an electronic marketplace such as, but not limited to, the following action types: listing an item for sale, selling an item, viewing an item listing, bidding on an item in an online auction, purchasing an item, submitting an offer to purchase an item, adding an item to an electronic shopping cart, adding an item to a wish list, or adding an item to a watch list. The user actions may also include interactions with the virtual assistant system 116. Each user action may be associated with a particular item category. For example, each item that is listed and transacted on the electronic marketplace has an associated item category, and thus, the item category associated with each action is the item category of the item involved in each action.

At operation 710, the familiarity scoring component 226 determines a familiarity score of the user profile with respect to the item category based on the user activity associated with the user profile. Consistent with some embodiments, the determining of the familiarity score may include determining whether any actions in the user activity are associated with the item category. For example, the familiarity scoring component 226 may identify actions that include listing an item from the item category for sale, selling an item from the item category, viewing an item listing for an item from the item category, bidding on an item from the item category, purchasing an item in the item category, submitting an offer to purchase an item in the item category, adding an item from the item category to an electronic shopping cart, adding an item from the item category to a wish list, or adding an item from the item category to a watch list. If the familiarity scoring component 226 determines there are no actions in the user activity that are associated with the item category, the familiarity scoring component 226 determines the familiarity score is zero.

Upon identifying actions associated with the item category, the familiarity scoring component 226 may assign a score to each identified action. The scores assigned to each identified action may, in some instances, be based on the action type. For example, each action type that includes an interaction with the electronic marketplace may have an associated predefined score. Further, the predefined score associated with each action type may vary by item category such that different scores may be associated with the same action type depending on the item category to which the utterance is associated. In scoring user actions related to interactions with the virtual assistant system 116, the familiarity scoring component 226 may score actions based on, for example, specificity of terms included in an utterance, tone, and micro-expression of the user. The familiarity scoring component 226 aggregates (e.g., sums) the scores assigned to each identified action to produce the familiarity score.

Consistent with some embodiments, the familiarity scoring component 226 determines the familiarity score using a graph theory approach. For example, the familiarity scoring component 226 may build a cluster graph having one or more clusters to represent the user activity. The cluster graph may be built in an offline manner and stored as part of the user profile data or may be built on the fly. The familiarity scoring component 226 computes a distance between the item category corresponding to the utterance and a cluster in the graph (e.g., the closest cluster or the farthest cluster). In these embodiments, the computed distance corresponds to the familiarity score.

At operation 715, the guidance manager 216 determines the familiarity score of the user profile with respect to the item category is below a threshold familiarity score. The threshold familiarity score may be a non-zero score, and thus, in instances in which the determined familiarity score is zero (e.g., when there are no user actions associated with the item category), the guidance manager 216 determines the familiarity score of the user profile with respect to the item category is below a threshold familiarity score is below zero. It shall be appreciated that non-zero familiarity scores may be also be below the threshold familiarity score. In these instances, though the user activity may include a limited number of actions associated with the item category, these actions do not give rise to the level of familiarity defined by the threshold familiarity score. The guidance manager 216 detects the anomalous relationship between the user profile and the item category based on determining the familiarity score of the user profile with respect to the item category is below the threshold familiarity score.

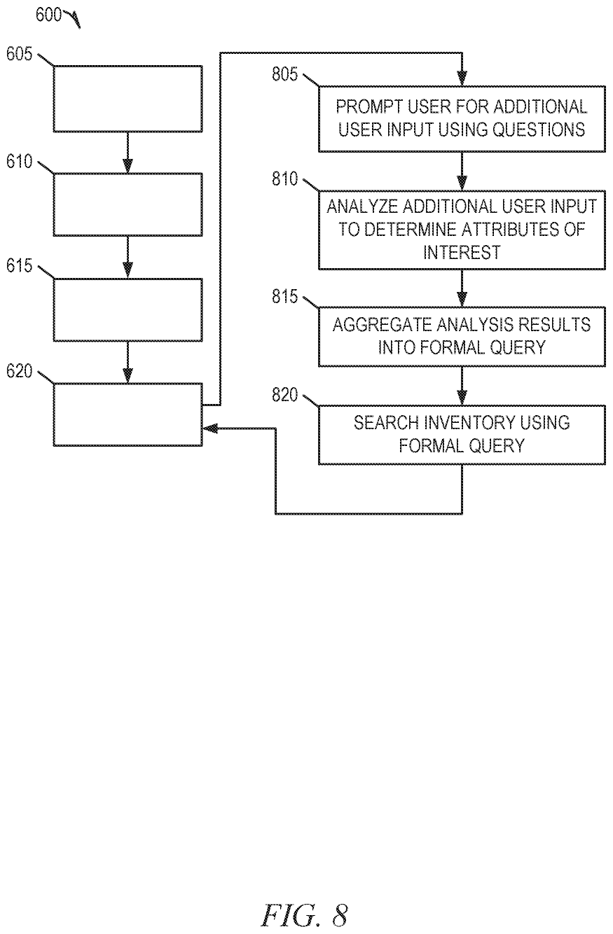

As shown in FIG. 8, the method 600 may, in some embodiments, further include operations 805, 810, 815, and 820. Consistent with some embodiments, the operations 805, 810, 815, and 820 may be performed as part of (e.g., as sub-operations or as a subroutine) operations 620, where the virtual assistant system 116 presents guidance with respect to the item category.

At operation 805, the guidance manager 216 causes the virtual assistant device 106 to prompt the user for additional user input using one or more questions. More specifically, the guidance manager 216 causes the virtual assistant device 106 to prompt the user for additional user input by causing the virtual assistant device 106 to ask the user the one or more questions. The guidance manager 216 may generate the one or more questions used to identify a user intent with respect to the item category, which may include identifying one or more attributes of interest with respect to the item category. Accordingly, the one or more questions may include at least question directed at ascertaining a high level intent of the user with respect to the item category and one or more follow up questions directed at identifying one or more item attributes of interest to the user. In some instances, the one or more follow up questions directed at identifying the one or more attributes of interest to the user may be generated based on the determined high level intent of the user.

In some embodiments, the guidance manager 216 may cause the virtual assistant device 106 to ask the user a predetermined number of questions. The predetermined number may, for example, be based on the item category. For example, items within a particular item category may have a set number of attributes, and thus, items in certain item categories may have potentially more item attributes of interest to the user, while other item categories have potentially fewer attributes of interest to the user.

At operation 810, the NLU component 214 analyzes additional user input received in response to the one or more questions. In analyzing the additional user input, the NLU component 214 may determine one or more attributes of interest with respect to the item category. The NLU component 214 may further determine one or more attribute values corresponding to the one or more attributes. In determining the one or more attributes of interest and corresponding attribute values, the NLU component 214 may also determine a user intent with respect to the item category as the user intent may determine, at least in part, the attributes of interest and their values.

At operation 815, the NLU component 214 aggregates the analysis results into a formal query for searching. The formal query may comprise a group of item attribute/value tags. The group of item attribute/value tags correspond to the one or more attributes of interest and the values corresponding to the attributes of interest. For example, the formal query may comprise “<category:shoes, color:red, brand:nike>.” The NLU component 214 may provide the formal query to the search component 220.

At operation 820, the search component 220 identifies items from the item category by searching an electronic marketplace product inventory, using the formal query. The items from the item category include the at least one item included as part of the guidance information presented by the virtual assistant device 106. In some embodiments, each of the items identified by the search component 220 are presented to the user by the virtual assistant device 106. In other embodiments, a subset of the items identified by the search component 220 are presented to the user by the virtual assistant device 106. The items may be ranked in accordance with the item attributes of interest to the user, and the subset of items may be selected based on the ranking.

As shown in FIG. 9, the method 600 may, in some embodiments, further include operations 905 and 910. Consistent with some embodiments, the operations 905 and 910 may be performed as part of (e.g., as sub-operations or as a subroutine) operations 620, where the virtual assistant system 116 presents guidance with respect to the item category.

At operation 905, the guidance manager 216 identifies an expert user with expertise related to the item category. The expertise of the expert user may be based on user profile data of the expert user. For example, the expert user may be identified based on user activity included in the user profile of the expert user indicating the expert user has at least a threshold number of transactions (sales or purchases) of items within the item category. In some embodiments, the user profile of the expert user may include one or more tags indicating expertise of the user.

At operation 910, the virtual assistant system 116 enables communication between the expert user to the user of the virtual assistant device 106. In one example, the virtual assistant system 116 enables the expert user to speak directly to the user of the virtual assistant device 106 via the virtual assistant device 106. In another example, the expert user may communicate with the virtual assistant system 116 and the virtual assistant system 116 causes the virtual assistant device 106 to present audio or textual data representative of the communication of the expert user, and user input provided by the user to the virtual assistant device 106 may be forwarded by the virtual assistant system 116 to the computing device of the expert user so as to enable communication between the two users.

Certain embodiments are described herein as including logic or a number of components, modules, or mechanisms. Modules may constitute either software modules (e.g., code embodied on a non-transitory machine-readable medium) or hardware-implemented modules. A hardware-implemented module is a tangible unit capable of performing certain operations and may be configured or arranged in a certain manner. In example embodiments, one or more computer systems (e.g., a standalone, client, or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired), or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses that connect the hardware-implemented modules). In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment, or a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., APIs).

### Electronic Apparatus and System

Example embodiments may be implemented in digital electronic circuitry, in computer hardware, firmware, or software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a standalone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special-purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or in a combination of permanently and temporarily configured hardware may be a design choice. Below are set out hardware (e.g., machine) and software architectures that may be deployed, in various example embodiments.

### Software Architecture

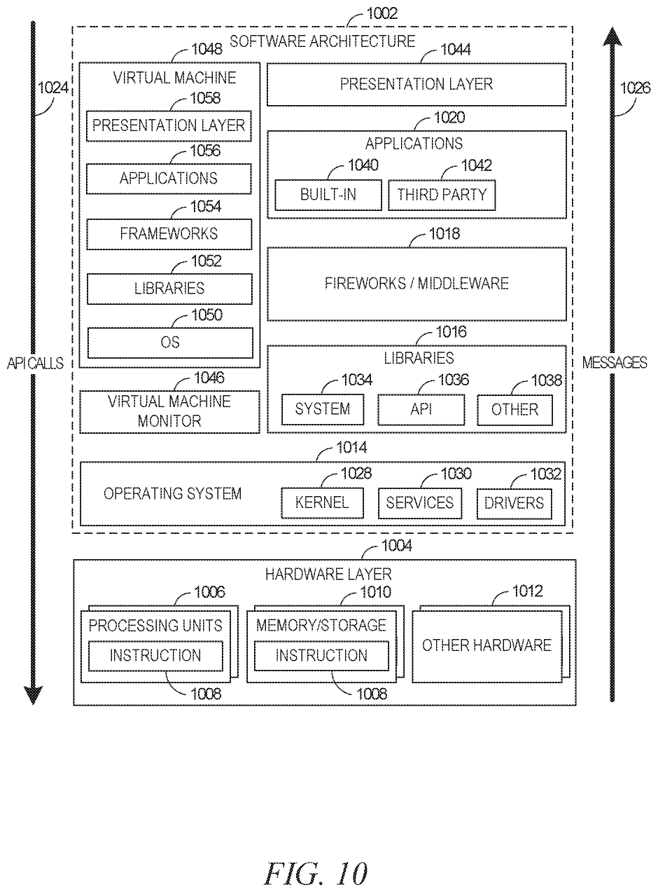

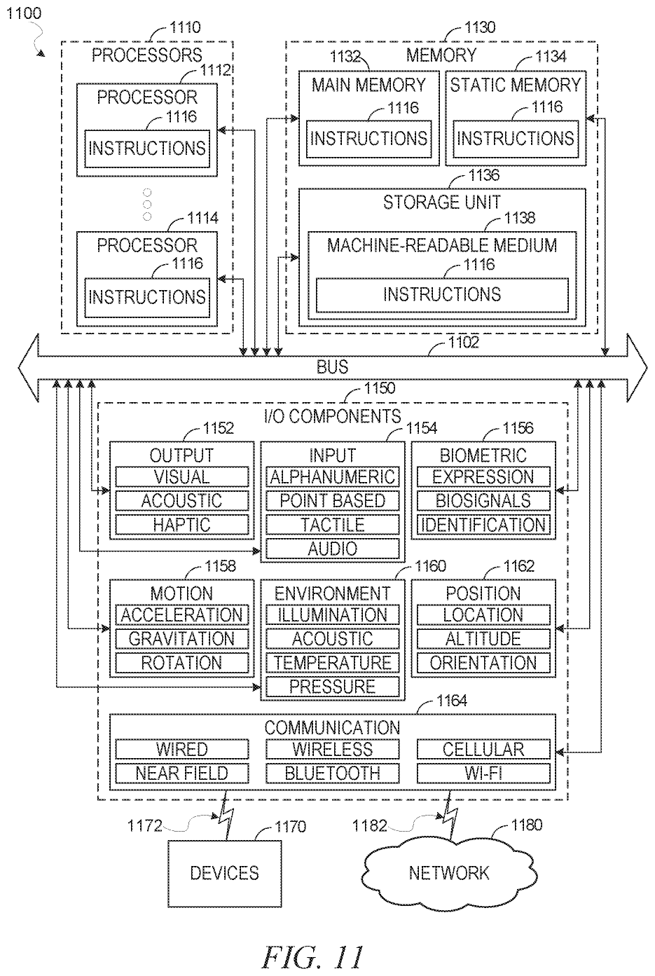

FIG. 10 is a block diagram illustrating an example of a software architecture that may be installed on a machine, according to some example embodiments. FIG. 10 is merely a non-limiting example of a software architecture, and it will be appreciated that many other architectures may be implemented to facilitate the functionality described herein. The software architecture 1002 may be executing on hardware such as a machine 1100 of FIG. 11 that includes, among other things, processors 1110, memory 1130, and input/output (I/O) components 1150. A representative hardware layer 1004 is illustrated and can represent, for example, the machine 1100 of FIG. 11. The representative hardware layer 1004 comprises one or more processing units 1006 having associated executable instructions 1008. The executable instructions 1008 represent the executable instructions of the software architecture 1002, including implementation of the methods, components, and so forth of FIGS. 1-9. The hardware layer 1004 also includes memory or storage modules 1010, which also have the executable instructions 1008. The hardware layer 1004 may also comprise other hardware 1012, which represents any other hardware of the hardware layer 1004, such as the other hardware illustrated as part of the machine 1000.

In the example architecture of FIG. 10, the software architecture 1002 may be conceptualized as a stack of layers, where each layer provides particular functionality. For example, the software architecture 1002 may include layers such as an operating system 1014, libraries 1016, frameworks/middleware 1018, applications 1020, and a presentation layer 1044. Operationally, the applications 1020 or other components within the layers may invoke API calls 1024 through the software stack and receive a response, returned values, and so forth (illustrated as messages 1026) in response to the API calls 1024. The layers illustrated are representative in nature and not all software architectures have all layers. For example, some mobile or special purpose operating systems may not provide a frameworks/middleware 1018 layer, while others may provide such a layer. Other software architectures may include additional or different layers.

The operating system 1014 may manage hardware resources and provide common services. The operating system 1014 may include, for example, a kernel 1028, services 1030, and drivers 1032. The kernel 1028 may act as an abstraction layer between the hardware and the other software layers. For example, the kernel 1028 may be responsible for memory management, processor management (e.g., scheduling), component management, networking, security settings, and so on. The services 1030 may provide other common services for the other software layers. The drivers 1032 may be responsible for controlling or interfacing with the underlying hardware. For instance, the drivers 1032 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 1016 may provide a common infrastructure that may be utilized by the applications 1020 and/or other components and/or layers. The libraries 1016 typically provide functionality that allows other software modules to perform tasks in an easier fashion than by interfacing directly with the underlying operating system 1014 functionality (e.g., kernel 1028, services 1030, or drivers 1032). The libraries 1016 may include system libraries 1034 (e.g., C standard library) that may provide functions such as memory allocation functions, string manipulation functions, mathematic functions, and the like. In addition, the libraries 1016 may include API libraries 1036 such as media libraries (e.g., libraries to support presentation and manipulation of various media formats such as MPEG4, H.264, MP3, AAC, AMR, JPG, PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 1016 may also include a wide variety of other libraries 1038 to provide many other APIs to the applications 1020 and other software components/modules.

The frameworks 1018 (also sometimes referred to as middleware) may provide a higher-level common infrastructure that may be utilized by the applications 1020 or other software components/modules. For example, the frameworks 1018 may provide various graphical user interface (GUI) functions, high-level resource management, high-level location services, and so forth. The frameworks 1018 may provide a broad spectrum of other APIs that may be utilized by the applications 1020 and/or other software components/modules, some of which may be specific to a particular operating system or platform.

The applications 1020 include built-in applications 1040 and/or third-party applications 1042. Examples of representative built-in applications 1040 may include, but are not limited to, a home application, a contacts application, a browser application, a book reader application, a location application, a media application, a messaging application, or a game application.

The third-party applications 1042 may include any of the built-in applications 1040, as well as a broad assortment of other applications. In a specific example, the third-party applications 1042 (e.g., an application developed using the Android™ or iOS™ software development kit (SDK) by an entity other than the vendor of the particular platform) may be mobile software running on a mobile operating system such as iOSTh, Android™, Windows® Phone, or other mobile operating systems. In this example, the third-party applications 1042 may invoke the API calls 1024 provided by the mobile operating system such as the operating system 1014 to facilitate functionality described herein.

The applications 1020 may utilize built-in operating system functions (e.g., kernel 1028, services 1030, or drivers 1032), libraries (e.g., system 1034, APIs 1036, and other libraries 1038), or frameworks/middleware 1018 to create user interfaces to interact with users of the system. Alternatively, or additionally, in some systems, interactions with a user may occur through a presentation layer, such as the presentation layer 1044. In these systems, the application/module “logic” can be separated from the aspects of the application/module that interact with the user.

Some software architectures utilize virtual machines. In the example of FIG. 10, this is illustrated by a virtual machine 1048. A virtual machine creates a software environment where applications/modules can execute as if they were executing on a hardware machine e.g., the machine 1100 of FIG. 11, for example). A virtual machine 1048 is hosted by a host operating system (e.g., operating system 1014) and typically, although not always, has a virtual machine monitor 1046, which manages the operation of the virtual machine 1048 as well as the interface with the host operating system (e.g., operating system 1014). A software architecture executes within the virtual machine 1048, such as an operating system 1050, libraries 1052, frameworks/middleware 1054, applications 1056, or a presentation layer 1058. These layers of software architecture executing within the virtual machine 1048 can be the same as corresponding layers previously described or may be different.

### Hardware Architecture

FIG. 11 illustrates a diagrammatic representation of a machine 1100 in the form of a computer system within which a set of instructions may be executed for causing the machine to perform any one or more of the methodologies discussed herein, according to an example embodiment. Specifically, FIG. 11 shows a diagrammatic representation of the machine 1100 in the example form of a computer system, within which instructions 1116 (e.g., software, a program, an application, an applet, an app, or other executable code) for causing the machine 1100 to perform any one or more of the methodologies discussed herein may be executed. For example, the instructions 1116 may cause the machine 1100 to execute the method 600 of FIGS. 6-9. Additionally, or alternatively, the instructions 1116 may implement FIGS. 2-5, and so forth. The instructions 1116 transform the general, non-programmed machine 1100 into a particular machine 1100 programmed to carry out the described and illustrated functions in the manner described. In alternative embodiments, the machine 1100 operates as a standalone device or may be coupled (e.g., networked) to other machines. In a networked deployment, the machine 1100 may operate in the capacity of a server machine or a client machine in a server-client network environment, or as a peer machine in a peer-to-peer (or distributed) network environment. The machine 1100 may comprise, but not be limited to, a server computer, a client computer, a personal computer (PC), a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1116, sequentially or otherwise, that specify actions to be taken by the machine 1100. Further, while only a single machine 1100 is illustrated, the term “machine” shall also be taken to include a collection of machines 1100 that individually or jointly execute the instructions 1116 to perform any one or more of the methodologies discussed herein.

The machine 1100 may include processors 1110, memory 1130, and I/O components 1150, which may be configured to communicate with each other such as via a bus 1102. In an example embodiment, the processors 1110 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 1112 and a processor 1114 that may execute the instructions 1116. The term “processor” is intended to include multi-core processors that may comprise two or more independent processors (sometimes referred to as “cores”) that may execute instructions contemporaneously. Although FIG. 11 shows multiple processors 1110, the machine 1100 may include a single processor with a single core, a single processor with multiple cores (e.g., a multi-core processor), multiple processors with a single core, multiple processors with multiples cores, or any combination thereof.

The memory 1130 may include a main memory 1132, a static memory 1134, and a storage unit 1136, both accessible to the processors 1110 such as via the bus 1102. The main memory 1130, the static memory 1134, and storage unit 1136 store the instructions 1116 embodying any one or more of the methodologies or functions described herein. The instructions 1116 may also reside, completely or partially, within the main memory 1132, within the static memory 1134, within the storage unit 1136, within at least one of the processors 1110 (e.g., within the processor's cache memory), or any suitable combination thereof, during execution thereof by the machine 1100.

The I/O components 1150 may include a wide variety of components to receive input, provide output, produce output, transmit information, exchange information, capture measurements, and so on. The specific I/O components 1150 that are included in a particular machine will depend on the type of machine. For example, portable machines such as mobile phones will likely include a touch input device or other such input mechanisms, while a headless server machine will likely not include such a touch input device. It will be appreciated that the I/O components 1150 may include many other components that are not shown in FIG. 11. The I/O components 1150 are grouped according to functionality merely for simplifying the following discussion and the grouping is in no way limiting. In various example embodiments, the I/O components 1150 may include output components 1152 and input components 1154. The output components 1152 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1154 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 1150 may include biometric components 1156, motion components 1158, environmental components 1160, or position components 1162, among a wide array of other components. For example, the biometric components 1156 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 1158 may include acceleration sensor components (e.g., accelerometer), gravitation sensor components, rotation sensor components (e.g., gyroscope), and so forth. The environmental components 1160 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 1162 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1150 may include communication components 1164 operable to couple the machine 1100 to a network 1180 or devices 1170 via a coupling 1182 and a coupling 1172, respectively. For example, the communication components 1164 may include a network interface component or another suitable device to interface with the network 1180. In further examples, the communication components 1164 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1170 may be another machine or any of a wide variety of peripheral devices (e.g., a peripheral device coupled via a USB).

Moreover, the communication components 1164 may detect identifiers or include components operable to detect identifiers. For example, the communication components 1164 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1164, such as location via Internet Protocol (IP) geolocation, location via Wi-Fi® signal triangulation, location via detecting an NFC beacon signal that may indicate a particular location, and so forth.

### Executable Instructions and Machine Storage Medium

The various memories (i.e., 1130, 1132, 1134, and/or memory of the processor(s) 1110) and/or storage unit 1136 may store one or more sets of instructions and data structures (e.g., software) embodying or utilized by any one or more of the methodologies or functions described herein. These instructions (e.g., the instructions 1116), when executed by processor(s) 1110, cause various operations to implement the disclosed embodiments.

As used herein, the terms “machine-storage medium,” “device-storage medium,” “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

### Transmission Medium

In various example embodiments, one or more portions of the network 1180 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 1180 or a portion of the network 1180 may include a wireless or cellular network, and the coupling 1182 may be a Code Division Multiple Access (CDMA) connection, a Global System for Mobile communications (GSM) connection, or another type of cellular or wireless coupling. In this example, the coupling 1182 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 1116 may be transmitted or received over the network 1180 using a transmission medium via a network interface device (e.g., a network interface component included in the communication components 1164) and utilizing any one of a number of well-known transfer protocols (e.g., hypertext transfer protocol (HTTP)). Similarly, the instructions 1116 may be transmitted or received using a transmission medium via the coupling 1172 (e.g., a peer-to-peer coupling) to the devices 1170. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 1116 for execution by the machine 1100, and includes digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a matter as to encode information in the signal.

### Computer-Readable Medium

The terms “machine-readable medium,” “computer-readable medium” and “device-readable medium” mean the same thing and may be used interchangeably in this disclosure. The terms are defined to include both machine-storage media and transmission media. Thus, the terms include both storage devices/media and carrier waves/modulated data signals.

### Language

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A system comprising:
a memory that stores instructions; and
one or more processors configured by the instructions to perform operations comprising:
receiving, via a digital assistant device, user input associated with a user profile, the user input including a user query;
identifying an item category corresponding to the user query based on an analysis of one or more terms included in the user query;
detecting an anomalous relationship between the user profile and the item category based on user activity associated with the user profile; and
in response to detecting the anomalous relationship between the user profile and the item category, causing the digital assistant device to provide guidance with respect to the item category, the providing of the guidance including presenting guidance information comprising one or more attribute values of at least one item in the item category, the one or more attribute values corresponding to one or more attributes of interest with respect to the item category determined from additional user input.

2. The system of claim 1, wherein the detecting of the anomalous relationship between the user profile and the item category includes:
accessing user profile data corresponding to the user profile, the user profile data including the user activity, the user activity including actions performed by a user corresponding to the user profile;
determining a familiarity score of the user profile with respect to the item category based on the user activity; and
determining the familiarity score is below a threshold familiarity score.

3. The system of claim 2, wherein the familiarity score is generated based on a number and type of actions in the user activity associated with the item category.

4. The system of claim 2, wherein the determining of the familiarity score comprises determining whether the user activity includes at least one action associated with the item category.

5. The system of claim 2, wherein the determining of the familiarity score comprises:
identifying, from the user activity, one or more actions associated with the item category;
assigning a score to each of the one or more actions; and
aggregating the scores assigned to each of the one or more actions scores to produce the familiarity score.

6. The system of claim 5, wherein the one or more actions associated with the item category include one or more of: listing an item from the item category for sale, selling an item from the item category, viewing an item listing for an item from the item category, bidding on an item from the item category, purchasing an item in the item category, submitting an offer to purchase an item in the item category, adding an item to an electronic shopping cart that is from the item category, adding an item from the item category to a wish list, or adding an item from the item category to a watch list.

7. The system of claim 2, wherein the determining of the familiarity score comprises:
building a cluster graph based on the user activity, the cluster graph comprising one or more clusters; and
determining, using the cluster graph, a distance between the item category and one of the one or more clusters, the distance corresponding to the familiarity score.

8. The system of claim 1, wherein the causing of the virtual assistant device to provide the guidance comprises:
causing the virtual assistant to prompt a user to provide the additional user input using one or more questions; and
analyzing the additional user input received in response to the one or more questions.

9. The system of claim 8, wherein the causing of the virtual assistant device to provide the guidance further comprises:
determining the one or more attributes of interest with respect to the item category based on the analyzing of the additional user input.

10. The system of claim 8, wherein the causing of the virtual assistant device to provide the guidance further comprises:
aggregating results of the analyzing the additional user input into a formal query; and
identifying the at least one item in the item category by searching an item inventory using the formal query.

11. The system of claim 8, wherein the causing of the virtual assistant to prompt the user to provide the additional user input using one or more questions comprises causing the virtual assistant device to ask a predetermined number of questions based on the item category.

12. The system of claim 1, wherein the causing of the virtual assistant device to provide the guidance comprises:
enabling communication between a user of the virtual assistant device and an expert user having expertise with the item category, the expertise of the expert user being identified based on user profile data associated with the expert user.

13. The system of claim 1, wherein the guidance information further includes an overall rating for the at least one item determined based on one or more user reviews for the at least one item.

14. A method comprising:
receiving, via a digital assistant device, user input associated with a user profile, the user input including a user query;
identifying an item category corresponding to the user query based on an analysis of one or more terms included in the user query;
detecting, by one or more processors of a machine, an anomalous relationship between the user profile and the item category based on user activity associated with the user profile; and
in response to detecting the anomalous relationship between the user profile and the item category, causing the digital assistant device to provide guidance with respect to the item category, the providing of the guidance including presenting guidance information comprising one or more attribute values of at least one item in the item category, the one or more attribute values corresponding to one or more attributes of interest with respect to the item category determined from additional user input.

15. The method of claim 14, wherein the detecting of the anomalous relationship between the user profile and the item category includes:
accessing user profile data corresponding to the user profile, the user profile data including the user activity, the user activity including actions performed by a user corresponding to the user profile;
determining a familiarity score of the user profile with respect to the item category based on the user activity; and
determining the familiarity score is below a threshold familiarity score.

16. The method of claim 15, wherein the determining of the familiarity score comprises:
identifying, from the user activity, one or more actions associated with the item category;
assigning a score to each of the one or more actions; and
aggregating the scores assigned to each of the one or more actions scores to produce the familiarity score.

17. The method of claim 16, wherein the one or more actions associated with the item category include one or more of: listing an item from the item category for sale, selling an item from the item category, viewing an item listing for an item from the item category, bidding on an item from the item category, purchasing an item in the item category, submitting an offer to purchase an item in the item category, adding an item to an electronic shopping cart that is from the item category, adding an item from the item category to a wish list, or adding an item from the item category to a watch list.

18. The method of claim 14, wherein the causing of the virtual assistant device to provide the guidance comprises:
causing the virtual assistant to prompt a user to provide additional user input using one or more questions;
analyzing the additional user input received in response to the one or more questions;
aggregating results of the analyzing the additional user input into a formal query; and
identifying the at least one item in the item category by searching an item inventory using the formal query.

19. The method of claim 18, wherein the causing of the virtual assistant device to provide the guidance further comprises:
determining the one or more attributes of interest with respect to the item category based on the analyzing of the additional user input.

20. A non-transitory machine-readable medium that stores instructions that, when executed by one or more processors, cause the one or more processors to perform operations comprising:
receiving, via a digital assistant device, user input associated with a user profile, the user input including a user query;
identifying an item category corresponding to the user query based on an analysis of one or more terms included in the user query;
detecting an anomalous relationship between the user profile and the item category based on user activity associated with the user profile; and
in response to detecting the anomalous relationship between the user profile and the item category, causing the digital assistant device to provide guidance with respect to the item category, the providing of the guidance including presenting guidance information comprising one or more attribute values of at least one item in the item category, the one or more attribute values corresponding to one or more attributes of interest with respect to the item category determined from additional user input.
